(19) United States
(12) Patent Application Publication
(10) Pub. No.: US 2006/0048196 A1
(43) Pub. Date: Mar. 2, 2006

(54) Wireless interactive entertainment and information display network systems

(76) Inventor: Frank Chuen-Foo Yau, Redwood City, CA (US)

Correspondence Address: FRANK YAU, 258 NICE COURT, REDWOOD CITY, CA, 94065, US

(21) Appl. No.: 11/215,757

(22) Filed: Aug. 29, 2005

Related U.S. Application Data
(60) Provisional application No. 60/605,946, filed on Aug. 30, 2004.

(51) Int. Cl. H04N 7/18

(52) U.S. Cl. 725/81

(57) ABSTRACT

A wireless interactive entertainment and information display network systems capable in deliver digital content to a group or groups of wireless interactive display apparatus for playback in real-time or on-demand and methods for timely and efficiently streaming, uploading, or transferring digital content from external media sources over wireless links to the network of wireless interactive display apparatus. The system comprises wireless interactive entertainment and information display apparatus, wireless access modules, routers, system management panel, and external media interface panel.

### RELATED APPLICATIONS

This application claims the priority of U.S. provisional patent application Ser. No. 60/605,946 filed Aug. 30, 2004.

### FIELD OF THE INVENTION

This invention relates to systems for Wireless Interactive Entertainment and Information Display Network Systems. Moreover, it pertains specifically to such systems for providing efficient digital content data delivery over wireless networks to interactive entertainment and information display apparatus for content storage and playback in real-time or on-demand.

### BACKGROUND OF THE INVENTION

With the advancement of electronic display and network technology, interactive entertainment and information content delivery are becoming commonplaces not just at homes and offices for individual choices. Similar personal interactive digital entertainment systems have been introduced in the recent years in passenger aircraft and trains using in-seat electronic displays and wired network systems. The prior art is cumbersome in installation due to routing of network cabling that also added costs from fabrication, material, labor, equipment, and maintenance. Aside from the physical and financial disadvantages of a wired network system, weight and space required for network cabling are less attractive especially for aircraft installations. Wireless network such as the IEEE 802.11 standards provides a cost effective alternative to wired network for delivering digital content. The wireless display network systems could provide cost effective solutions that could extend to providing large networks of individual interactive entertainment and information display systems in any aircraft passenger cabins, train passenger cabins, passenger buses, passenger cars, passenger ferry cabins, concert halls, lecture halls, libraries, campuses, dormitories, auditoriums, stadiums, entertainment facilities, exercise facilities, waiting-rooms, shopping facilities, or even residential communities where digital content can be broadcasted or delivered to a group of wireless interactive displays for storage and playback in real-time on-demand.

Prior art in the wireless applications are not sufficient for transmitting or receiving large digital files especially for video content streaming, uploading or transferring for a network of users to playback on-demand. There is a need for a wireless interactive entertainment and information display network systems that could efficiently deliver digital content for playback in real-time or on-demand.

### SUMMARY OF THE INVENTION

In view of the limitations now present in the prior art, the present invention provides a new and useful Wireless Interactive Entertainment and Information Display Network system apparatus which is simpler in construction, more universally usable and more versatile in operation than known system of this kind.

The purpose of the present invention is to provide a new Wireless Interactive Entertainment and Information Display Network system that has many novel features not offered by the prior art that result in a new Wireless Interactive Entertainment and Information Display Network system which is not apparent, obvious, or suggested, either directly or indirectly by any of the prior art.

The aspect of the invention is a system for efficient digital content data delivery to a group or groups of individual wireless interactive entertainment and information display apparatus for playback in real-time or on-demand over wireless network in, but not limited to, an aircraft passenger cabin, train passenger cabin, passenger bus, passenger auto, passenger ferry cabin, concert hall, lecture hall, library, campus, dormitory, auditorium, stadium, entertainment facility, exercise facility, waiting-room, shopping facility, or residential community where the digital content data could be uploaded from external media sources. The content can be playback in real-time or stored for interactive playback individually on-demand at the display apparatus. The present invention generally comprises of a system with wireless interactive entertainment and information display apparatus, wireless access modules, routers, a system management panel, and an external media interface panel.

The foregoing has outlined, in general, the physical aspects of the invention and is to serve as an aid to better understanding the more complete detailed description in which is to follow. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### OBJECTS OF THE INVENTION

Accordingly several advantages and objects of the present invention are:

A principal object of the present invention is to provide a Wireless Interactive Entertainment and Information Display Network Systems apparatus that will overcome the deficiencies of the prior art devices.

An object of the present invention is to provide a Wireless Interactive Entertainment and Information Display Network Systems apparatus that use wireless network to upload or deliver digital content data to a group or groups of wireless interactive display apparatus efficiently and timely for playback individually on-demand or in real-time.

Another object of the present invention is to provide a Wireless Interactive Entertainment and Information Display Network Systems apparatus that use IEEE 802.11a, 802.11g, 802.11n, 802.16, Ultra-Wideband (UWB), Wireless USB, or any other wireless standards in providing 54 Mbps or higher link rate to achieve data throughput rates of 45 Mbps or higher, which equals to or better than the bandwidth for T3 digital transmission line to provide efficient and timely uploading of digital content in a secure setting to a group or groups of wireless interactive display apparatus using Wireless Data Throughput Optimization (WDTO) technique which combines the utilizations of UDP network protocol, multicasting, peer-to-multi-peers ad-hoc network broadcasting, wireless network parameters tuning, data frame fragmentation and reassemble optimization techniques, data packet concatenation, and data file segmentation transfer techniques.

It is intended that any other advantages and objects of the present invention that become apparent or obvious from the detailed description or illustrations contained herein are within the scope of the present invention.

### BRIEF DESCRIPTION OF THE DRAWINGS

The following drawings further describe by illustration the advantages and objects of the present invention. Each drawing is referenced by corresponding figure reference characters within the “DETAILED DESCRIPTION OF THE INVENTION” section to follow.

FIG. 1 is a pictorial representation of a wireless interactive entertainment and information display network system according to the present invention.

FIG. 2 is a flow chart illustrating the process of the wireless interactive display network system content upload session using WDTO technique according to the present invention.

FIG. 3 is a flow chart illustrating the process of the wireless interactive display network system content streaming session using WDTO technique according to the present invention.

FIG. 4 is a pictorial representation of an alternate embodiment of a simplified wireless interactive entertainment and information display network system according to the present invention.

FIG. 5 is a flow chart illustrating an alternate embodiment of a process of the wireless interactive display network system content upload session using simplified WDTO technique according to the present invention.

### DETAILED DESCRIPTION OF THE INVENTION

Referring now descriptively to the drawings, the attached figures illustrate a Wireless Interactive Entertainment and Information Display Network Systems apparatus:

The following description of the preferred embodiment of the invention is not intended to limit the scope of the invention but rather to enable any person skilled in the art to make and use this invention.

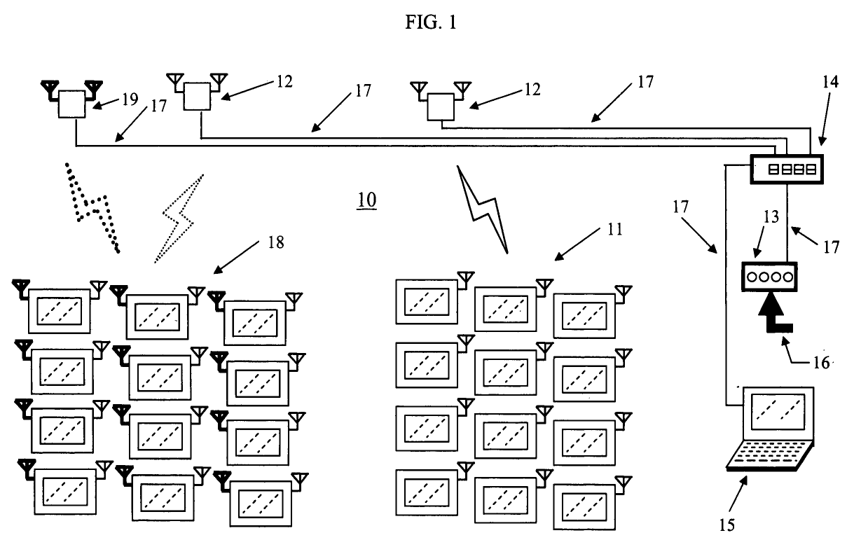

As shown in FIG. 1, the invention is a wireless interactive display network system 10, which is comprised of wireless interactive entertainment and information display apparatus 11, wireless access modules 12, routers 14, system management panel 15, and external media interface panel 13. Apparatus of the invention shall meet the related regulatory requirements for the environment where they are intended.

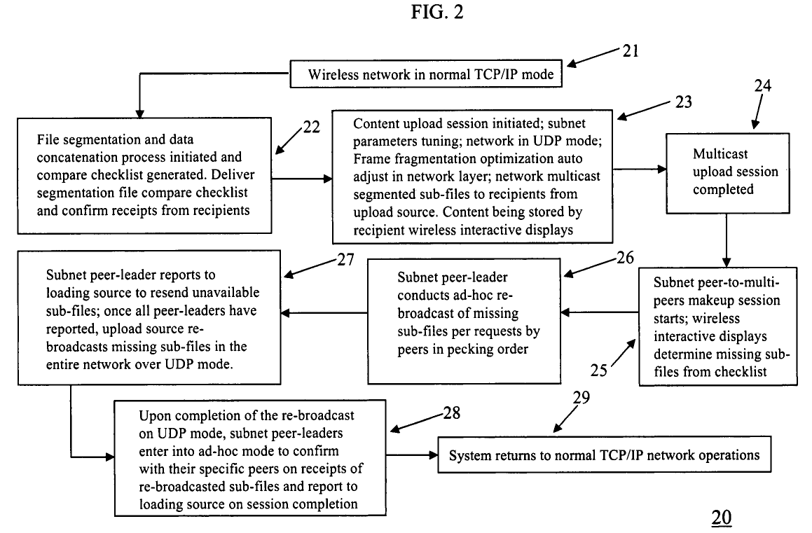

As shown in FIG. 1, the wireless interactive display 11 consists of touch-screen or other wired or remote input control device for user input selections; it also consists of computer circuitry and software capable of processing digital data that maybe encoded and or encrypted, for storage or playback of video, audio, and digital image rendering on-demand. Audio is accessed via a, wired or wireless, headset(s) or speaker(s). A wireless transceiver module, which operates in IEEE 802.11a, 802.11g, 802.11n, 802.16, Ultra-Wideband (UWB), Wireless USB, or any other wireless standards in providing 54 Mbps or higher link rate where bandwidth optimization can achieve data throughput rates of 45 Mbps or higher using WDTO 20 technique as explained in FIG. 2, and its antenna is integrated with the wireless transceiver module circuitry. The respective computer circuitry can be contained within the display enclosure or a separate apparatus mounted in proximity and connected to the electronic display apparatus. The wireless interactive displays can be integrated into seats, fix mounted on structures or other equipment, or detachable. The wireless interactive display is connected to a sufficient power source. The wireless interactive displays are wirelessly linked to their pre-assigned subnet wireless access module 12. Alternatively, wireless interactive display apparatus 11 need not to be linked in the wireless network once content upload process 20, as shown in FIG. 2, is completed for interactive playback on-demand. Content can be deleted by prearranged timeline, on-demand, pre-programmed, or preset parameters.

As shown in FIG. 1, the wireless access module 12 consists of antenna connected to transceiver circuitry with digital signal process capability for Ethernet network 17 interface. The transceiver module, which operates in IEEE 802.11a, 802.11g, 802.11n, 802.16, Ultra-Wideband (UWB), Wireless USB, or any other wireless standards in providing 54 Mbps or higher link rate where bandwidth optimization can achieve data throughput rates of 45 Mbps or higher using WDTO 20 technique as explained in FIG. 2, operates with application software and firmware to implement multicast and unicast network operations with the wireless interactive displays 11. The purpose of the wireless access module 12 is to enable wireless transmission of digital data between the wireless interactive displays 11 and external media interfaces 16 including the system management panel 15 via the router 14. The wireless access module 12 is connected to a sufficient power source, and it is generally installed in the ceiling or at an elevated level to enable line-of-sight wireless link with the group of wireless interactive displays 11 within its own subnet; therefore, each subnet has one designated wireless access module 12. Each subnet is assigned a channel with any overlapping channels isolated or spread apart physically in the layout of the network. The maximum number of wireless interactive displays 11 assigned to each subnet depends on bandwidth requirements; the optimum number of wireless interactive displays 11 in the subnet shall be 253 or less. The available channels depend on the particular world region and the local regulations.

As shown in FIG. 1, the router 14 consist of circuitry capable of managing, processing, and routing digital packet data between the particular subnet wireless access module 12, external media interface panel 13 and system management panel 15 via Ethernet 17; there could be a Ethernet switch in the network if the distance is over 300 feet. Multiple routers 14 are possible for larger network with multiple subnets. The router 14 is connected to a sufficient power source.

As shown in FIG. 1, the system management panel 15 consists of a computer, with touch-screen or keyboard interface, which provides digital data processing, storage, content display, and network interface. The user interface display and control can be portable and remotely connected to the panel with wiring or wirelessly. The purpose of the system management panel 15 is to provide control, monitor, maintenance, and interface with all the components in the wireless network 10. It also provides digital content backup storage, DVD playback, collect system data, and configure system parameters. The system management panel 15 may also act as the interface for the wireless system 10 to the Internet where it would have DHCP server functions assigning pseudo IP addresses for data traffic between the Internet and the wireless interactive displays 11. It also function as the clearing-house and interface for any financial or payment transactional requirements in the wireless network 10. The system management panel 15 is connected to a sufficient power source.

As shown in FIG. 1, the external media interface panel 13 consists of connection points for external media inputs 16 of digital data such as text, graphics, video and audio. This could also include, but not limited to, digital media server, content loader, analog to digital media converter that could convert VCR tape content to MPEG format digital video and audio content for example, also DVD player, digital satellite receiver/decoder, or the Internet.

As shown in FIG. 1, Ethernet 17 is either 10/100Base-T Ethernet or Gigabit Ethernet (copper wire or fiber-optic).

As shown in FIG. 1, an alternate embodiment would include wireless interactive displays 18 that operate with dual wireless modules for dual wireless link operations either for backup or increase wireless subnet bandwidth. The wireless interactive displays 18 shall have additional Random Access Memory (RAM) capacity to process and buffer the additional data from the dual wireless link operations. This particular alternate embodiment would require an additional wireless access module 19 in the respective subnet. The additional wireless access module 19 operates either in a different channel within the same wireless standard or a different wireless standard. Alternatively, the wireless access module 19 can operate in dual-band so to support the dual wireless link operations or linking other wireless access module(s) 19 in the network.

As shown in FIG. 2, WDTO 20 (Wireless Data Throughput Optimization) technique, which consists of combined utilization of UDP network protocol, multicasting, peer-to-multi-peers ad-hoc network broadcasting, wireless network parameters tuning, data frame fragmentation and reassemble optimization techniques, data packet concatenation, and data file segmentation transfer techniques, is used during content upload session. During normal operation period 21, the wireless network 10, as shown in FIG. 1, is in TCP/IP mode where each wireless interactive display 11 or 18 has a unique MAC address and a pre-assigned static IP in respect to its subnet. The respective subnet channel is preset and fixed. The digital content delivery in the normal mode without WDTO 20 bandwidth optimization is accomplished with either or both unicast and multicast streaming data delivery in TCP/IP and UPD mode respectively.

As shown in FIG. 2, digital content files such as video and audio files are uploaded to the wireless interactive displays 11 or 18 using segmentation file transfer technique 22 where a digital file is segmented into optimal size of data packets of sub-files for transfers and later reassemble as a whole file for storage and playback. The segmentation of the files could be accomplished external to the network prior to introduce into the system or process real-time by the system management panel 15. Data concatenation process bounds multiple small packets as sub-files for transfers to increase throughput. A segmentation file compare and reassembly checklist 22 is generated and to be sent to each intended recipients with confirmation prior to the upload session. The checklist will be used by the recipient wireless interactive displays 11 to determine any missing packets requiring resend during the make-up session.

As shown in FIG. 2, system is initialized for upload session 23; subnet wireless access modules 12 or 19 will send a “stay awake” broadcast messages and announcement traffic indication map to all recipients. The respective wireless interactive displays 11 or 18, wireless access modules 12 or 19, and system management panel 15 switch to UDP mode for multicast session. Subnet parameter tuning will turn all respective wireless interactive displays 11 or 18 into receive only mode and turn off send request protocol, receipt acknowledgement and error correction from wireless interactive displays during the upload session to eliminate data collision and reduce protocol overhead thus increases the throughput data rate. Beacons, reason codes, status codes, from the wireless access modules 12 or 19 would also be turned off. During the UDP upload session, data packets are framed for the entire network or specific subnets. During partial network upload, only the respective subnet or subnets switch to UDP upload mode. Further more, the segmented sub-files will be transferred in fragmented frames on the network layer where the size of the frames is optimized by setting the fragmentation threshold depending on the network available bandwidth, activities, and recipient populations so balancing between reducing frame headers overhead and subsequent error correction requirements. The fragmentation threshold is to be determined and adjusted accordingly in each session or pre-determined by fragmented packets transfer reassemble technique application software.

As shown in FIG. 2, while the segmented sub-file frames are being received by the recipient wireless interactive displays 11 or 18, the data packets are processed and reassembled back into sub-files and subsequently rebuilt into whole digital files as the intended content for digital storage. Once the multicast session from the original upload source is completed 24, the peer-to-multi-peers make-up session 26 will be confined to its respective individual subnet with a pre-designated peer-leader from one of wireless interactive display 11 or 18 in the subnet group to conduct the ad-hoc make-up session among its own peers within the subnet where it will solicit each wireless interactive display 11 or 18 peer one at a time in pecking order for missing sub-files list generated using the sub-file data compare checklist 22. The peer-leader will conduct the session to rebroadcast the requested sub-files in multicast mode confines to its own subnet in its respective channel without interfering with other subnets as other subnets are also broken up to conduct their own make-up sessions in sub-groups. Once a wireless interactive display 11 or 18 is confirmed to have obtained the missing sub-files, it will move on to another wireless interactive display 11 or 18 for the same process. As the make-up session continues, it is expected that the number of missing sub-file requests would be reduced as the process continue down the pecking order and the process speeds up. If the peer leader does not have the requested sub-files available, it would request another peer within the subnet to broadcast the missing segmented sub-files packets if available or otherwise it will request the upload source 16 or system management panel 15 to resend in the subsequent process.

As shown in FIG. 2, the system management panel 15 also conducts the make-up session with the loading source 16. The backup content for make-up could also come from the system management panel 15. Peer-leaders report 27 to the loading source 16 or system management panel 15 on requests for any unavailable sub-files in its respective subnet. Once all peer-leaders reports are confirmed, the system reenters into UDP and multicast mode to retransmit the specific missing sub-files only. The network wide makeup session is to be conducted by the system management panel 15 or the loading source 16 with the subnet peer-leaders in pecking order with confirmations on successes.

As shown in FIG. 2, upon completion of the network wide make-up session in UDP mode, the subnet peer-leaders will enter back into ad-hoc session 28 to confirm with specific peers on the receipt of the previously unavailable sub-files or re-conduct make-up an additional time as required.

As shown in FIG. 2, once all the peer-leaders from the subnets have reported back, or via query, to the loading source 16 or system management panel 15 that the make-up sessions are completed, the system returns the entire wireless network to normal TCP/IP operations 29.

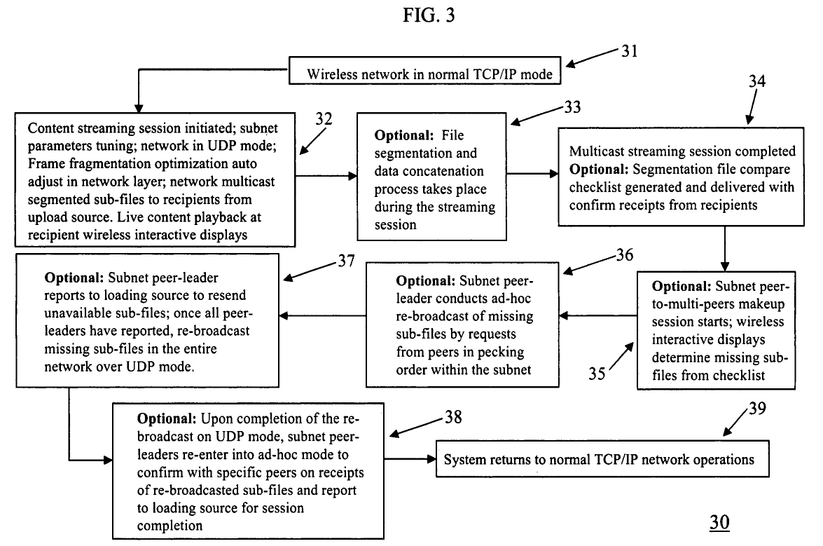

As shown in FIG. 3, during live streaming session 30 using WDTO technique, the respective subnet or subnets will switch from TCP/IP to UDP mode for multicast streaming session 32 with same subnet parameter tuning and frame fragmentation optimization techniques as content upload process 20 as shown in FIG. 2. If the streaming digital content were intended for storage for on-demand playback as well as available for real-time broadcast playback on the wireless interactive displays 11 or 18, file segmentation 33 would be performed during the live streaming session where the checklist would be generated and sent after the streaming session is completed. Subnet peer-to-multi-peers ad-hoc makeup session 35 and subsequent processes marked as Optional tasks would also take place similar to content upload process 20 as shown in FIG. 2.

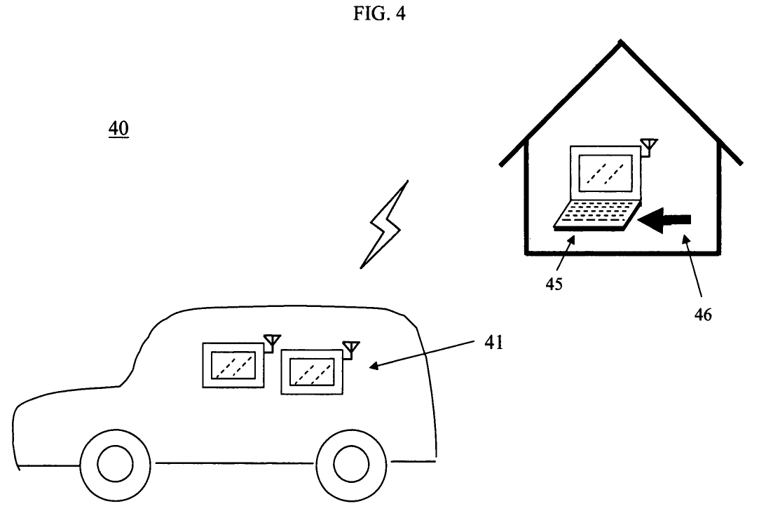

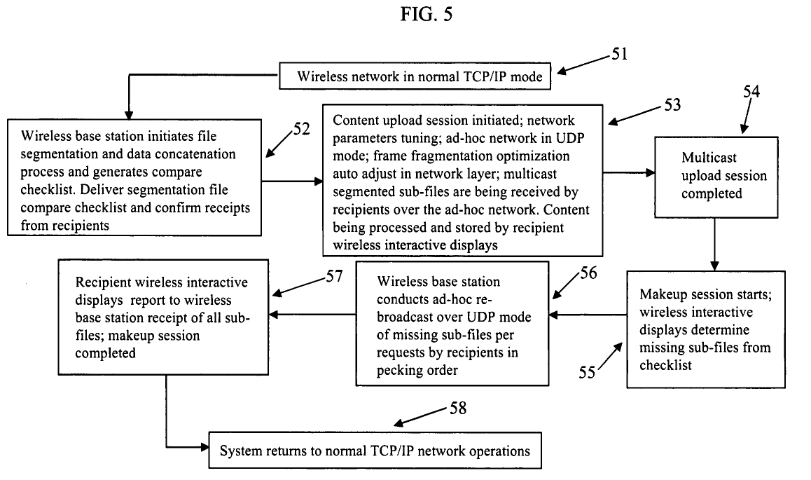

As shown in FIG. 4, an alternate embodiment with single network application such as, but not limited to, autos or taxis with seatback wireless interactive entertainment and information display system apparatus where a simplified ad-hoc network system 40 with a wireless base station 45 similar to system management panel 15, as shown in FIG. 1, but with added self-contained wireless module and antenna or connected directly to a wireless access point (not shown). Wireless base station 45 provides wireless digital content upload and system management capability to the wireless interactive displays 41 installed in vehicle. The wireless interactive display 41 is similar to wireless interactive display 11 or 18, as shown in FIG. 1. The external digital content 46 can be fed via Internet or other digital media, such as DVD, to the wireless base station 45 located most commonly in a home or office which would have line-of-sight range, commonly within 300 feet, to conduct the ad-hoc wireless upload sessions 50, as shown in FIG. 5, with the wireless interactive displays 41 in the vehicle or vehicles. The uploaded content can be playback on-demand whenever the wireless interactive displays 41 are powered in the vehicle anywhere. The wireless interactive displays 41 can rejoin with the wireless base station 45 anytime for content upload or system management functions while the vehicle is within range of the wireless base station 45 or respective remote wireless access point or access points with directional or high-gain antenna deployed in strategic locations (not shown). The wireless base station 45 is connected to sufficient power source. The wireless interactive displays 41 are connected to sufficient power source in the vehicle.

As shown in FIG. 5, an alternate embodiment of the WDTO technique 20, but not limited to, is a simplified digital content upload process 50 for a single wireless network with multiple wireless interactive display apparatus 41 as shown in FIG. 4. The simplified WDTO process 50 is similar to WDTO process 20, as shown in FIG. 2, with wireless base station 45 initiates file segmentation process 52 and checklist delivery with confirmation from the recipient wireless interactive displays 41. Network parameter tuning 53 takes place prior to ad-hoc multicast upload session in UDP mode. Frame fragmentation optimization is used during the upload session to optimize data throughput. The segmented sub-files are uploaded via the wireless ad-hoc session 53 for process and storage in the wireless interactive displays 41. The makeup session 56 is conducted by the wireless base station 45 directly with the wireless interactive displays 41 in pecking order to re-broadcast any missing sub-files as requested. Once the wireless base station 45 confirms that the makeup session is completed with the wireless interactive displays 41, the system network 40 will return to TCP/IP operations.

The present invention is not limited to the following types of network and content security implementations that include encryption and decryption methods such as public key encryption, triple-DES or MPEG4 format for content protections.

The wireless network is set up as closed network to be invisible to non-intended users with ESSID broadcast disabled, and wireless access modules are preset to restrict access to only specific MAC addresses using MAC address authentication and association control. Furthermore, wireless network security would also include any of these techniques and methods such as 802.11i standards with TKIP (Temporal Key Integrity Protocol), Stateful Packet Inspection (SPI) firewall, port mapping, 152-bit WEP encryption, WPA, intrusion detection using Intrusion Detection System (IDS) with logging and reporting alerts, IPSec-based VPN endpoint tunnels for secure remote connections, 168-bit IPSec-based 3DES encrypted tunnels for secure WAN connection, Secure Socket Layer (SSL) remote management capable, PEAP (Protected Extensible Authentication Protocol).

Financial or payment transactions over the wireless network would implement secure transactions using methods such as symmetric key encryption and SSH (Secure Shell).

It is further intended that any other embodiments of the present invention that result from any changes in application or method of use or operation, method of manufacture, shape, size, or material which are not specified within the detailed written description or illustrations contained herein yet are considered apparent or obvious to one skilled in the art that are within the scope of the present invention. Furthermore, as any person skilled in the art of wireless interactive entertainment systems will recognize from the previous detailed description and from the figures, modifications and changes can be made to the preferred embodiment of the invention without departing from the scope of this invention.

I claim:

1. A wireless interactive entertainment and information display network systems that enable efficient and timely deliver of digital content data in a wireless network to multi-users for individual or simultaneous playback comprising: a group or groups of multiple wireless interactive display apparatus for digital content playback in real-time or on-demand by individual selections; wireless access module(s) provides wireless links for transmitting and receiving digital content data between the external digital media source(s) or interface(s) and group(s) of wireless interactive display apparatus, and alternatively, wireless links to other wireless access module(s) in the network; a router for each zone or sections of the wireless network, which directs network data to and from the respective wireless access module(s) and the external media source(s), interface(s), or system management panel(s); the external media interface panel(s) provides physical connection point(s) to any external digital media sources or interfaces; system management panel(s) provides digital content storage for network access and operator interfaces to the wireless network systems for control, monitoring, and maintenance functions.

2. The wireless interactive entertainment and information display network systems of claim 1, wherein the wireless network functions in both unicast and multicast streaming data delivery in TCP/IP and UDP mode respectively.

3. The wireless interactive entertainment and information display network systems of claim 1, wherein the wireless network provides efficient data communication bandwidth management for digital content delivery using IEEE 802.11a, 802.11g, 802.11n, 802.16, Wireless USB, Ultra-Wideband (UWB), or any other wireless standards in providing 54 Mbps or higher link rate.

4. The wireless interactive entertainment and information display network systems of claim 1, wherein the digital content is video, audio, or graphical image rendering in digital data formats such as, but not limited to, MPEG, MP3, JPEG, TIFF, HTML, or XML.

5. The wireless interactive display apparatus of claim 1, wherein the wireless interactive display is an electronic device which is capable in wireless communication, data processing, data storage, and displaying digital image and video rendering, and audio playback by user control or programmed control.

6. The wireless access module of claim 1, wherein the wireless access module is a device comprises of electronics circuits that provide wired network communication interface(s) with radio network communication in single-band or dual-band of the same or different wireless standards.

7. The external digital media sources of claim 1, wherein include, but not limited to, digital media server(s), digital content loader(s), analog to digital media converter(s) that converts analog media format such as NTSC or PAL to digital data format, DVD player(s), digital camera(s), or digital terrestrial or satellite TV receiver(s)/decoder(s).

8. The external digital media interfaces of claim 1, wherein include, but not limited to, the Internet or an intranet(s).

9. The router of claim 1, wherein comprising a network router or a network switch which interconnects wired network interfaces of wireless access module(s), external media panel(s), and system management panel(s) with cabling.

10. The system management panel of claim 1, wherein the system management panel can be a self-contained unit or separate units where the user interface display and control, that can be portable, are remotely connected with wiring or wirelessly to the unit that contains the content storage and network interface functions.

11. A method of wireless interactive entertainment and information display network systems apparatus to achieve wireless network communication bandwidth optimization comprising: the use of IEEE 802.11a, 802.11g, 802.11n, 802.16, Wireless USB, Ultra-Wideband (UWB), or any other wireless standards in providing 54 Mbps or higher link rate to achieve data throughput rates of 45 Mbps or higher using Wireless Data Throughput Optimization (WDTO) technique which combines the utilizations of UDP network protocol, multicasting, peer-to-multi-peers ad-hoc network broadcasting, wireless network parameters tuning, data frame fragmentation and reassemble optimization techniques, data packet concatenation, and data file segmentation transfer techniques.
